(19) United States
(12) Patent Application Publication
(10) Pub. No.: US 2003/0065757 A1
(43) Pub. Date: Apr. 3, 2003

(54) Automatic networking device configuration method for home networking environments

(76) Inventors: Duane Mentze, Roseville, CA (US); David McAnaney, Davis, CA (US)

Correspondence Address: HEWLETT-PACKARD COMPANY, Intellectual Property Administration, P.O. Box 272400, Fort Collins, CO, 80527-2400, US

(21) Appl. No.: 09/969,248

(22) Filed: Oct. 1, 2001

(51) Int. Cl. G06F 15/177

(52) U.S. Cl. 709/222

(57) ABSTRACT

A method for automatically configuring network devices connected to a gateway type network in accordance with the invention determines if the network devices have been assigned static Internet protocol (IP) addresses and assigns static IP addresses to each network device that has not been assigned a static IP address.

### FIELD OF THE INVENTION

The present invention relates to small local area networks, and more particularly, to local area networks in homes.

### BACKGROUND OF THE INVENTION

Home networking is gaining popularity with the advent of high-speed Internet links, such as DSL, cable modems, and others. The topology, layout and device configurations of these home networks are sometimes dramatically different from traditional networks used in commercial establishments, such as corporations. This presents a challenge to network device configuration software that need to configure network devices, that is, devices that are connected to the network, within a home networking environment with home owners who have limited or no networking experience. Two common examples of network devices are printers and personal computers. Printers are connected to the network so that they can be shared by multiple users, such as multiple personal computers that are also connected to the network. It should be understood that there are many other network devices and the reference to printers as network devices is by way of example and not of limitation.

Most network devices available today default to dynamic host configuration protocol (DHCP). In many commercial environments, network devices are configured via DHCP and this default setting is maintained when the network devices are installed. In other commercial network environments, experienced network administrators override the default DHCP and assign a static internet protocol (IP) address, subnet mask, and default gateway.

As used herein, a “gateway type network” means a network having network devices with local, non-routable addresses where the network is linked to the Internet through a gateway where the ability of the network devices to communicate with the Internet through the network and gateway is dependent upon the gateway having the DHCP assigned IP address from the ISP. Although such a gateway type network would typically be installed in homes, it should be understood that such a gateway type network could also be installed in non-home environments.

The problem with the DHCP configuration mode in gateway type networks as defined above is that the DHCP configuration mode often will not properly configure the network device. When in DHCP configuration mode, the network device requests an IP configuration (address, subnet mask and default gateway) from a local DHCP server. Many broadband Internet Service Providers (ISP's) use DHCP to configure users' personal computers (PCs). Consequently, when the network device starts-up in DHCP mode, it can “steal” the user's IP address assigned by the ISP. Therefore, when the user's PC subsequently boots, it will not be assigned an IP address and will not be able to access the Internet or other network resources if the ISP limits the number of IP addresses assigned to each customer.

Another problem with the DHCP configuration mode, is that in DHCP configuration mode, the network device is assigned a new address each time it is powered-on. Unless the ISP supports dynamic domain services (DDNS) and the client, such as a PC connected to the network, addresses the network device by host name, which is unlikely, it can be difficult for the client to contact the network device with the network device's IP address changing each time it is powered-on.

### SUMMARY OF THE INVENTION

A method for automatically configuring network devices connected to a gateway type network in accordance with the invention determines if the network devices have been assigned static Internet protocol (IP) addresses and assigns static IP addresses to each network device that has not been assigned a static IP address. In an aspect of the invention, the method is implemented in configuration software that runs on a computer that is connected to the network. In an aspect of the invention, this computer is a computer that is connected to the network to configure the network devices and then removed.

In an aspect of the invention, determining whether a network device has been assigned a static IP address includes determining if that network device has been configured with TCP/IP protocol. If not, that network device is assigned a static IP address. If so, TCP/IP protocol configuration information is retrieved from that network device and the determination whether that network device has been assigned a static IP address determined from the retrieved TCP/IP protocol configuration information.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a prior art gateway type network; and

FIG. 2 is a flow chart of the method of this invention.

### DETAILED DESCRIPTION OF THE PREFERRED EMBODIMENTS

The following description of the preferred embodiment(s) is merely exemplary in nature and is in no way intended to limit the invention, its application, or uses.

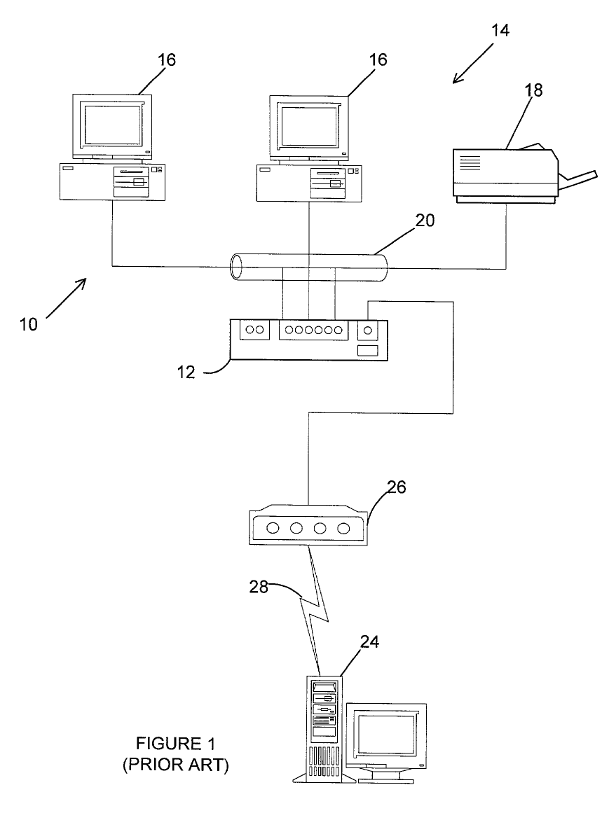

FIG. 1 shows a topology for a prior art gateway type network 10 which illustratively is an ethernet network. It should be understood that the topology and use of ethernet are exemplary and that the inventive method can be utilized with other topologies and networks other than ethernet networks, such as Home PNA (phone network alliance) and wireless 802.11b. Gateway type network 10 has a hub 12. Network devices 14, such as PCs 16 and printer 18, are connected to hub 12 by ethernet network 20. It should be understood that hub 12 and network devices 14 each have an appropriate network interface card, such as an ethernet network interface card where the network is an ethernet network.

Hub 12 is also coupled to a broadband ISP 24 via modem 26 and communications link 28. Broadband ISP 24 is illustratively a cable or DSL broadband ISP with communications link 28 being a broadband cable or DSL phone line, respectively, and modem 26 being a cable or DSL modem, respectively.

One of PC's 16 is illustratively set-up as a gateway for handling Internet communications. The PC 16 that is set-up as a gateway is configured by broadband ISP 24 for Internet communications as described above. The other PC's 16 use the PC 16 that is set-up as a gateway to communicate with the Internet using the technique known as tunneling.

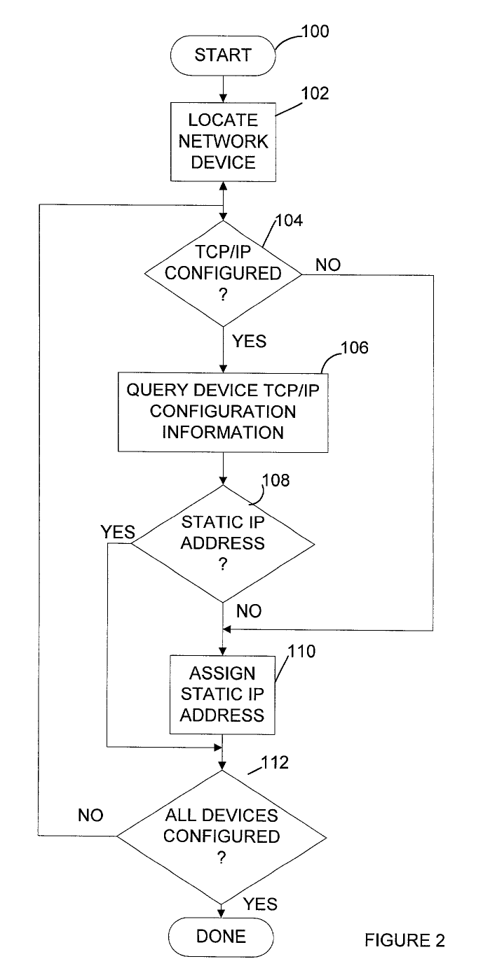

Referring to FIG. 2, a method of accordance with the invention of configuring network devices 14 of gateway type network 10 is described. The inventive method is illustratively implemented in configuration software. The configuration software could reside in a network device 14, hub 12, or in a computer that is connected to the network when a network device is configured and then removed. It should be understood that the configuration software implementing the inventive method can reside on any device connected to the network in a manner that permits the device to configure network devices 14 when the configuration software is run.

The method starts at step 100 when the configuration software is run. The configuration software is run each time a new network device 14 is added to gateway type network 10, or if there is a need to reconfigure any existing network device 14. At step 102, the configuration software discovers the network devices 14 connected to gateway type network 10 and, optionally, a user of gateway type network 10 chooses which of the discovered network devices 14 are to be configured. In this regard, the PC 16 that is configured as a gateway is excluded from being configured, preferably automatically by the configuration software, or manually by the user. The configuration software then proceeds to configure each of the network devices 14 to be configured. At step 104, the configuration software checks to see if the TCP/IP protocol has been configured on the next network device 14 to be configured. The TCP/IP protocol configuration for that network device 14 can have been done manually or via DHCP. If that network device 14 has been configured with the TCP/IP protocol, the configuration software retrieves the TCP/IP configuration information from that network device 14 at step 106. If that network device 14 has not been configured with the TCP/IP protocol, the configuration software branches to step 110.

At step 108, the configuration software determines whether that network device 14 has been assigned a static IP address and not configured via DHCP. If that network device 14 has not been assigned a static IP address, then at step 110 the configuration software assigns a static IP address to that network device 14, and in doing so, overrides any DHCP configuration so that the network device 14 releases any IP address assigned by DHCP. Illustratively, the configuration software uses known configuration techniques, such as the IPv4 Auto-Configuration to assign the static IP address, as described in the IETF specification entitled Automatically Choosing an IP Address in an Ad-Hoc IPv4 Network. The configuration software then checks at step 112 whether all the network devices 14 to be configured have been configured. If not, the configuration software returns to step 104. If so, the configuration of network devices 14 is complete and the configuration software ends.

Existing Internet protocol standards reserve an IP address range for static IP addresses which cannot be used by DHCP. The static IP addresses assigned to the network devices 14 in accordance with the invention are taken from the range of IP addresses reserved for static IP addresses. Thus, the static IP addresses assigned to network devices 14 won't conflict with the IP address assigned to gateway device 22 by ISP 24 using DHCP configuration.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for automatically configuring network devices connected to gateway type network, comprising the steps of:
(a) determining if the network devices have been assigned static Internet protocol (IP) addresses; and
(b) assigning a static IP address to each network device that has not been assigned a static IP address.

2. The method according to claim 1 wherein the step of determining whether a network device has been assigned a static IP address includes determining if that network device has been configured with TCP/IP protocol, retrieving TCP/IP protocol configuration information from that network device if it has been configured with TCP/IP protocol and determining from the retrieved TCP/IP protocol configuration information from that network device whether that network device has been assigned a static IP address.

3. The method according to claim 2 wherein a static IP address is assigned to a network device if it is determined that the network device has not been configured with TCP/IP protocol.

4. A method for automatically configuring network devices in a gateway type network, comprising the steps of:
(a) determining what network devices are connected to the gateway type network;
(b) determining whether any of the network devices that are connected to the gateway type network are configured with TCP/IP protocol;
(c) upon determining that any of the network devices connected to the gateway type network are not configured with TCP/IP protocol, assigning a static Internet protocol (IP) address to each of the network devices that are not configured with TCP/IP protocol;
(d) determining based upon a TCP/IP protocol configuration of each network device connected to the gateway type network that is configured with TCP/IP protocol whether that network device has a static IP address; and
(c) for those network devices connected to the gateway type network and configured with TCP/IP protocol that do not have static IP addresses, assigning those network devices static IP addresses.

5. In a gateway type network having network devices connected thereto, a method for automatically configuring the network devices, comprising the steps of:
(a) providing a computer connected to the gateway type network and configuration software on that computer;
(b) running the configuration software;
(c) determining with the configuration software whether any of the network devices have static Internet protocol (IP) addresses; and
(d) automatically assigning with the configuration software static IP addresses to those network devices that don't have static IP addresses

6. In a gateway type network to which network devices can be connected, a method for configuring network devices connected to a gateway type network, comprising the steps of:
(a) determining which network devices are connected to the gateway type network;
(b) providing a computer connected to the gateway type network and configuration software on that computer;
(c) running the configuration software;
(d) determining with the configuration software if any of the network devices connected to the network are configured with TCP/IP protocol;
(e) assigning with the configuration software static Internet protocol (IP) addresses to those network devices connected to the gateway type network that are not configured with TCP/IP protocol;
(f) retrieving with the configuration software from any of the network devices connected to the gateway type network that are configured with TCP/IP protocol TCP/IP configuration information;
(g) determining with the configuration software from the retrieved TCP/IP configuration information whether any of the network devices connected to the gateway type network and configured with TCP/IP protocol have static IP addresses; and
(h) assigning with the configuration software static IP addresses to those network devices connected to the gateway type network and configured with TCP/IP protocol that don't have static IP addresses.
